(19) United States
(12) Patent Application Publication
(10) Pub. No.: US 2024/0397347 A1
(43) Pub. Date: Nov. 28, 2024

(54) OBTAINING AND STORING SITE CONFIGURATION FILES

(71) Applicant: T-MOBILE INNOVATIONS LLC, Overland Park, KS (US)

(72) Inventor: Sean J. RANK, Spring Hill, KS (US)

(21) Appl. No.: 18/324,687

(22) Filed: May 26, 2023

(51) Int. Cl. H04W 24/02; H04W 24/08

(52) U.S. Cl. CPC H04W 24/02; H04W 24/08

(57) ABSTRACT

The present disclosure describes a system and method for managing site configuration in a radio access network (RAN) environment. Trigger events are identified through data analysis, including network congestion, signal degradation, or performance deviation. Upon detecting a trigger event, specific site configuration data associated with the event is extracted from the RAN node. The extracted site configuration data is utilized to generate a new configuration file, ensuring the seamless update of network settings while maintaining the integrity of the RAN.

### SUMMARY

A high-level overview of various aspects of the invention is provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to technology associated with managing capacities for network management systems, substantially as shown in and/or described in connection with at least one of the figures, and as set forth more completely in the claims.

In aspects set forth herein, and at a high level, the technology described herein relates to a multi-network management system capable of communicating with a plurality of radio access network (RAN) nodes via a plurality of network operation systems (e.g., network managers), wherein each network operating system that is in communication with the multi-network management system corresponds to one or more RAN nodes. A RAN node may include, for example, one or more core network nodes, relay devices, integrated access and backhaul nodes, macro cells, small cells, picocells, relay base stations, other types of base stations, other network components, or one or more combinations thereof. In embodiments, a network operations system managed by the multi-network management system can include a network manager for classical RAN, cloud RAN, mobile and packet core and enterprises, end-to-end 4G/5G radio slicing operations, other types of network management operations, or one or more combinations thereof.

In embodiments, the multi-network management system changes the management of RANs by offering an efficient and proactive approach to configuration updates and trigger event detection. It comprises a network manager, a node analyzer, a KPI analyzer, and a site configuration controller. The network manager oversees the entire system, facilitating communication and coordination between the different components.

In some embodiments, a node analyzer continuously monitors and collects data from individual RAN nodes, while the KPI analyzer analyzes performance metrics across the network. These analyzers work in tandem to identify trigger events based on deviations or abnormalities in key performance indicators. When a trigger event is detected, the site configuration controller extracts the current site configuration file from the affected RAN node and saves it separately, without overwriting the existing file. This ensures the preservation of valuable previous configurations while enabling seamless updates. By proactively detecting trigger events and efficiently managing site configurations, the system optimizes network performance, enhances stability, and improves the overall user experience within the RAN.

This summary is provided to introduce example concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for the multi-network management system, in accordance with aspects herein;

FIG. 2 depicts another example operating environment for the multi-network management system, in accordance with aspects herein;

FIG. 3 depicts an example embodiment of the multi-network management system, in accordance with aspects herein;

FIG. 4 illustrates an example flowchart for utilizing the multi-network management system, in accordance with aspects herein; and

FIG. 5 depicts an example user device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:
3G Third-Generation Cellular Communication System
4G Fourth-Generation Cellular Communication System
5G Fifth-Generation Cellular Communication System
CD-ROM Compact Disk Read Only Memory
CDMA Code Division Multiple Access
CQI Channel Quality Information
CS Circuit Switch
CSF Channel State Feedback
CSI Channel State Information
D2D Device-to-Device
eNB Evolved Node B
gNB Next Generation Node B
GPRS General Packet Radio Service
GSM Global System for Mobile communications
DVD Digital Versatile Discs
EEPROM Electrically Erasable Programmable Read Only Memory
eMBB enhanced Mobile Broadband
EMS Enhanced Messaging Service
E-RAB E-UTRAN Radio Access Bearer
E-UTRAN Evolved Universal Terrestrial Radio Access Network
FD-MIMO Full-Dimension Multiple-Input Multiple-Output
GPS Global Positioning System
GSM Global Standards for Mobile communications
IoT Internet of Things
KPI Key Performance Indicator
LAN Local Area Network
LTE Long Term Evolution
MCS Modulation Coding Scheme
MIMO Multiple-Input Multiple-Output
mm wave Millimeter wave
MME Mobility Management Entity
MMS Multimedia Messaging Service
mMTC massive Machine Type Communications
MU-MIMO Multi-User Multiple-Input Multiple-Output
NR New Radio
P2P Peer-to-Peer
PC Personal Computer
PDA Personal Digital Assistant
PDP Packet Data Protocol
QOS Quality of Service
RAM Random Access Memory
RAN Radio Access Network
RAT Radio Access Technology
RBS Radio Base Station
RF Radio-Frequency
ROM Read Only Memory
RRC Radio Resource Control
RSRP Reference Signal Received Power
RSRQ Reference Transmission Receive Quality
RSSI Received Signal Strength Indicator
SDCCH Stand-alone Dedicated Control Channel
SINR Signal to Interference and Noise Ratio
SMS Short Message Service
SNR Signal-to-Noise Ratio
SRS Sound Reference Signal
TCH Traffic Channel
TDMA Time Division Multiple Access
UE User Equipment
UMTS Universal Mobile Telecommunications System
URLLC Ultra-Reliable Low Latency Communications
VLAN Virtual Local Area Network

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. Further, the term “some” may refer to “one or more.” Additionally, an element in the singular may refer to “one or more.” The term “combination” (e.g., one or more combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

As used herein, the phrase “based on” shall be construed as a reference to an open set of conditions. For example, an example step that is described as “based on X” may be based on both X and additional conditions, without departing from the scope of the present disclosure. In other words, as used herein, the phrase “based on” shall be construed in the same manner as the phrase “based at least in part on.”

The term “mm wave,” as used herein, may refer to the extremely high frequency band (e.g., from 30 GHz to 300 GHz). Additionally or alternatively, in some embodiments, a mm wave transmission includes one or more frequency ranges of 24 GHZ, 26 GHZ, 28 GHZ, 39 GHz, and 52.6-71 GHz.

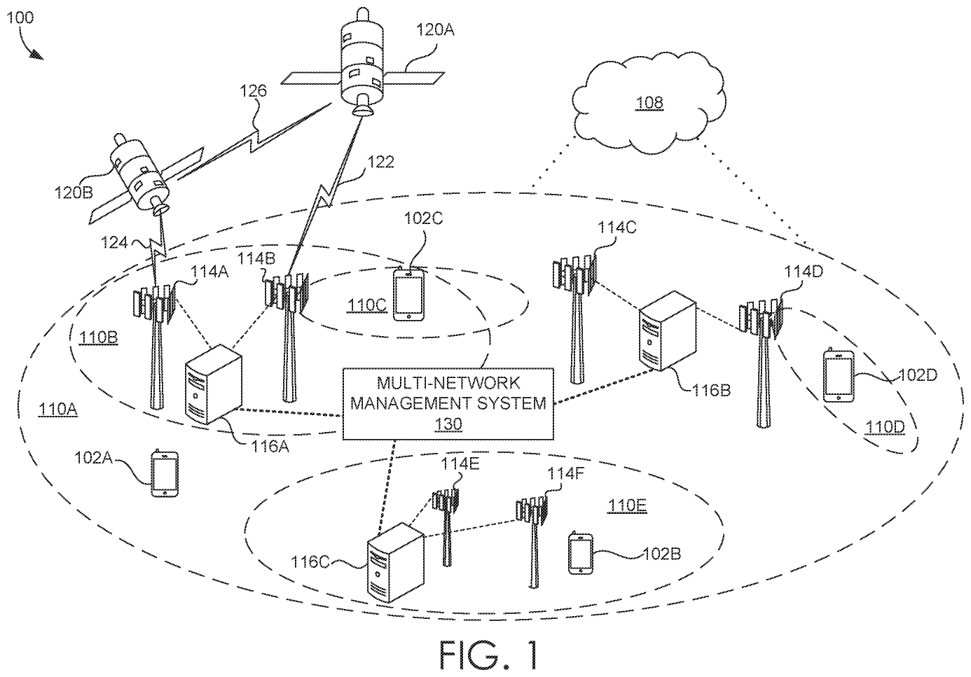

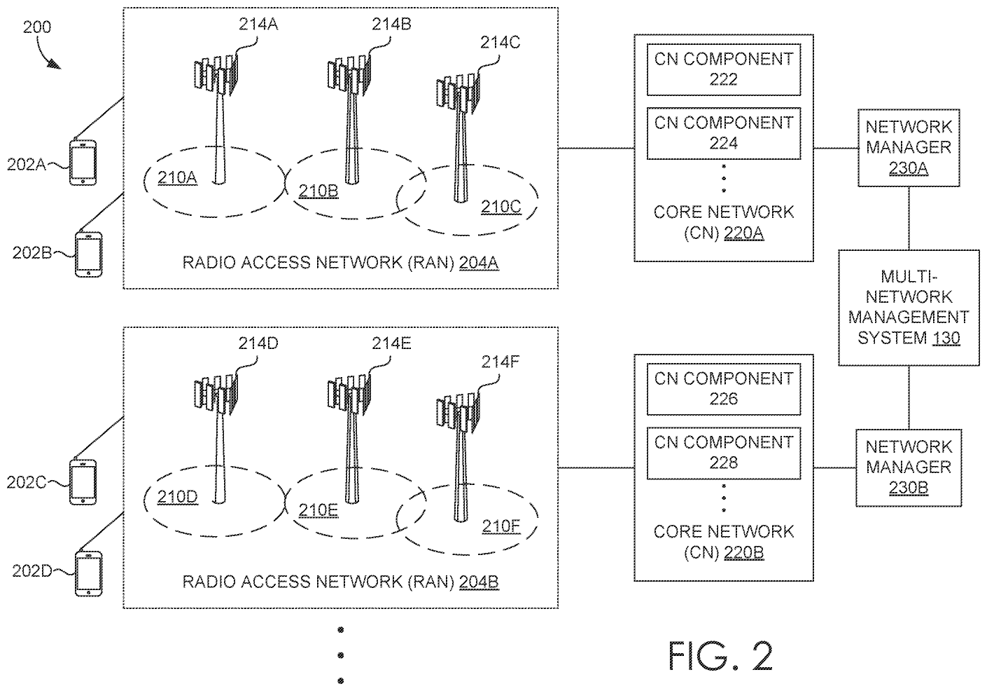

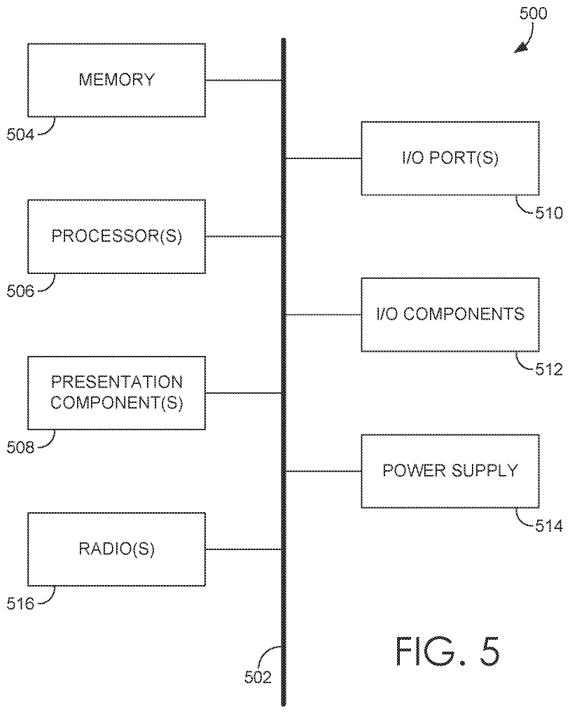

Additionally, a “user device,” as used herein, is a device that has the capability of using a wireless communications network, and may also be referred to as a “computing device,” “mobile device,” “user equipment,” “wireless communication device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in some embodiments, similar to user devices 102A-102D described herein with respect to FIG. 1, similar to user devices 202A-202D described herein with respect to FIG. 2, or similar to user device 500 described herein with respect to FIG. 5.

In embodiments, a user device may include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof. In some aspects, the user device is a wearable device having a camera, microphone, RFID, GPS, another sensor, or one or more combinations thereof, to capture data in real-time or near real-time (e.g., one or more strings of text, image data, video data, audio data, location data, other types of data, or one or more combinations thereof).

The wearable devices and other user devices, for example, can transmit the data obtained by their corresponding sensors to other user devices. For example, the sensor data obtained by a user device can be further transmitted for another user device to perform positional tracking (e.g., six degrees of freedom positional tracking) associated with the user device capturing the sensor data in real-time. In embodiments, a user device can access sensors, application data, tracking data, map data, other user device data, or one or more combinations thereof, for packet transmissions to a user device. In some embodiments, a wearable device can be a watch-type electronic device, a glasses-type wearable device, an upper-torso wearable device (e.g., a shirt having sensors affixed on or within the material of the shirt or a device that is attachable to the shirt), another type of wearable device, or one or more combinations thereof.

In aspects, a user device discussed herein may be configured to communicate using one or more of 4G (e.g., LTE), 5G, 6G, another generation communication system, or one or more combinations thereof. In some aspects, the user device has components to establish a 5G connection with a 5G gNB, and to be served according to 5G over that connection. In some aspects, the user device may be an E-UTRAN New Radio-Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

“Telecommunication service” refers to the transfer of information (e.g., without the use of an electrical conductor as the transferring medium). Telecommunication services may be provided by one or more telecommunication network providers. Telecommunication services may include, but are not limited to, the transfer of information via radio waves (e.g., Bluetooth®), satellite communication, infrared communication, microwave communication, Wi-Fi, mm wave communication, and mobile communication. Embodiments of the present technology may be used with different telecommunication technologies or standards, including, but not limited to, CDMA 1×Advanced, GPRS, Ev-DO, TDMA, GSM, WiMAX technology, LTE, LTE Advanced, other technologies and standards, or one or more combinations thereof.

A “network” providing the telecommunication services (e.g., network 108 of FIG. 1) may be one or more telecommunications networks, or a portion thereof. The telecommunications network might include an array of devices or components (e.g., one or more base stations). The network can include multiple networks, and the network can be a network of networks. In embodiments, the network or a portion thereof is a core network, such as an evolved packet core, which may include at least one MME, at least one serving gateway, and at least one Packet Data Network gateway. The MME may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides telecommunication services comprising one or more of a voice service, a message service (e.g., SMS messages, MMS messages, instant messaging messages, an EMS service messages), a data service, other types of telecommunication services, or one or more combinations thereof, to user devices or corresponding users that are registered or subscribed to a telecommunication service provider to utilize the one or more services. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or one or more combinations thereof.

Components of the telecommunications network, such as terminals, links, and nodes (as well as other components), can provide connectivity in various implementations. For example, components of the network may include core network nodes, relay devices, integrated access and backhaul nodes, macro eNBs, small cell eNBs, gNBs, relay base stations, other network components, or one or more combinations thereof. The network may interface with one or more base stations through one or more wired or wireless backhauls. As such, the one or more base stations may communicate to devices via the network or directly. Furthermore, user devices can utilize the network to communicate with other devices (e.g., a user device(s), a server(s), etc.) through the one or more base stations.

As used herein, the term “base station” (used for providing UEs with access to the telecommunication services) generally refers to one or more base stations, nodes, RRUs control components, and the like (configured to provide a wireless interface between a wired network and a wirelessly connected user device). A base station may comprise one or more RAN nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like. A base station may be, in some embodiments, similar to base stations 114A-114F described herein with respect to FIG. 1 or similar to base stations 214A-214F described herein with respect to FIG. 2.

In embodiments, the “RAN node” may refer to a base transceiver station, a radio base station, an access point, a radio transceiver, a NodeB, an eNB, a gNB, a Home NodeB, a Home eNodeB, another type base station, or one or more combinations thereof. The RAN node may comprise one or more of a macro base station, a small cell or femtocell base station, a relay base station, another type of base station, or one or more combinations thereof. In aspects, the RAN node may be configured as FD-MIMO, massive MIMO, MU-MIMO, cooperative MIMO, 3G, 4G, 5G, another generation communication system, or one or more combinations thereof. In addition, the RAN node may operate in an extremely high frequency region of the spectrum (e.g., from 30 GHz to 300 GHz), also known as the millimeter band.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, RANs play a crucial role in modern telecommunications, enabling wireless connectivity for a wide range of devices and applications. RANs consist of base stations or access points that provide the necessary infrastructure for transmitting and receiving wireless signals. To ensure optimal performance and efficient operation, RANs require effective management and configuration.

Traditionally, RAN management systems have faced challenges when it comes to configuration updates. When a configuration change is required, the existing approach often involves overwriting the entire site configuration file. This approach poses several drawbacks. Firstly, it leads to the loss of valuable previous settings, such as optimized antenna parameters or specific network configurations, which can have a detrimental impact on network performance. Secondly, overwriting the entire configuration file introduces the risk of errors or misconfigurations during the update process, potentially causing disruptions or service degradation. Thus, there is a need for an improved approach that allows for seamless updates while preserving valuable previous configurations.

Furthermore, the lack of proactive trigger event detection in traditional RAN management systems has been a limitation. Trigger events, such as network congestion, environmental changes, equipment failures, or configuration update requirements, can significantly impact RAN performance and efficiency. However, without timely detection and response to these trigger events, network operators may face challenges in optimizing network resources, mitigating interference, or adapting to changing network conditions. Therefore, there is a need for a system and method that proactively detects trigger events and initiates appropriate actions for efficient RAN management.

To address these challenges, a novel system and method are proposed for the efficient management of RANs. This system aims to overcome the limitations of traditional approaches by introducing a configuration management solution that avoids overwriting the entire site configuration file. Additionally, the system incorporates trigger event detection capabilities to enable proactive response and optimize network performance based on the occurrence of various trigger events. By preserving previous configurations and proactively addressing trigger events, the proposed system enhances the stability, adaptability, and overall performance of RANs in the dynamic telecommunications landscape.

Those skilled in the art will appreciate that the computing devices described herein need not be limited to conventional personal computers, and can include other computing configurations, including servers, hand-held devices, multi-processor systems, a microprocessor based or programmable consumer electronics, network PCs, minicomputers, mainframe computers, other computing devices, or one or more combinations thereof. Similarly, the computing devices need not be limited to stand-alone computing devices, as the mechanisms may also be practiced in distributed computing environments where tasks are performed by remote processing devices that are linked through a wireless telecommunications network. In a distributed computing environment, program modules may be located in both local and remote memory storage devices.

Turning now to FIG. 1, example operating environment 100 supports the multi-network management system within one or more telecommunications networks, in accordance with one or more embodiments disclosed herein. Example environment 100 is but one example of a suitable environment for the multi-network management system and the associated techniques disclosed herein, and is not intended to suggest any limitation as to the scope of use or functionality of the invention. Neither should the environment 100 be interpreted as having any dependency or requirement relating to any one or combination of components illustrated. For example, in some embodiments, the example operating environment 100 can include additional components not depicted.

Example operating environment 100 includes user devices 102A-102D, network 108, coverage areas 110A-110E, base stations 114A-114F, network managers 116A-116C, satellites 120A and 120B, communication link 124 corresponding to satellite 120B and base station 114A, communication link 122 corresponding to satellite 120A and base station 114B, communication link 126 between satellites 120A and 120B, and multi-network management system 130. Example operational environment 100 is but one example environment for the multi-network management system 130. For example, another embodiment may include additional base stations.

Example operating environment 100 having network 108 and coverage area 110A may be associated with one or more of a non-terrestrial network, an LTE network, an LTE-A network, an LTE-A Pro network, an NR network, a mm wave network, another type of network, or one or more combinations thereof. In some embodiments, the example operating environment 100 may support enhanced broadband communications, ultra-reliable (e.g., mission critical) communications, low latency communications, communications with low-cost and low-complexity devices, another type of communication, or one or more combinations thereof. In some embodiments, one or more communications between one or more devices in example operating environment 100 may correspond to the enhanced broadband communication, ultra-reliable communication, low latency communication, another type of communication, or one or more combinations thereof.

In embodiments, example environment 100 can utilize both licensed and unlicensed radio frequency bands. For example, the example environment 100 may employ License Assisted Access, LTE-Unlicensed radio access technology, or NR technology in an unlicensed band (e.g., 5 GHz industrial, scientific, and medical band). When operating in unlicensed radio frequency bands, base stations, satellites, or user devices may employ carrier sensing for collision avoidance and detection. In some examples, operations in unlicensed bands may be based on a carrier aggregation configuration and component carriers operating in a licensed band. Operations in unlicensed spectrum may include downlink transmissions, uplink transmissions, P2P transmissions, D2D transmissions, another type of unlicensed spectrum operation, or one or more combinations thereof. As such, one or more communications corresponding to the multi-network management system 130 may correspond to a licensed or unlicensed radio frequency band, a 5 GHz industrial band, a 5 GHz scientific band, a 5 GHz medical band, a particular carrier aggregation configuration of a licensed band, a P2P transmission, a D2D transmission, another type of spectrum operation, or one or more combinations thereof.

In embodiments, user devices 102A-102D may wirelessly communicate via one or more wireless telecommunication services provided by one or more base stations (e.g., user device 102B may wireless communicate via a wireless telecommunication service provided by base station 114E or 114F), one or more satellites (e.g., user device 102A may wireless communicate via a wireless telecommunication service provided by satellite 120A, 120B another satellite, or one or more combinations thereof), other types of wireless telecommunication devices, or one or more combinations thereof. In example environment 100, network 108, base stations 114A-114F, and satellites 120A-120B can provide coverage area 110A for supporting communication signals according to one or more radio access technologies. Supported communication signals within coverage area 110A can include MU-MIMO and SU-MIMO transmissions, for example. As such, one or more communications corresponding to the multi-network management system 130 may correspond to the wireless telecommunication services provided within coverage area 110A.

In embodiments, the user devices 102A-102D can be stationary, mobile, or one or more combinations thereof at different times. The user devices 102A-102D may be able to communicate with various types of devices, such as other UEs, various types of base stations, or various types of network components (e.g., one or more RAN nodes including one or more core network nodes, relay devices, integrated access and backhaul nodes, other types of RAN nodes, or one or more combinations thereof). In embodiments, one or more of the user devices 102A-102D may have different capabilities. For instance, a user device can be wearable devices having a camera, microphone, RFID, GPS, another sensor, or one or more combinations thereof. In some embodiments, a user device is a wearable device can be a watch-type electronic wearable device, a glasses-type wearable device, an upper-torso wearable device (e.g., a shirt having sensors affixed on or within the material of the shirt or a device that is attachable to the shirt), another type of wearable device, or one or more combinations thereof.

In embodiments, one or more of the user devices 102A-102D may include one or more of a unit, a station, a terminal, or a client, for example. The user devices 102A-102D may also include a wireless local loop station, an IoT device, an Internet of Everything device, a machine type communication device, an evolved or enhanced machine type communication device, another type of user device, or one or more combinations thereof. The machine type communication device or the evolved or enhanced machine type communication device may include, for example, one or more robots, drones, remote devices, sensors, meters, monitors, location tags, etc., that may communicate with a base station, another device (e.g., remote device), or some other entity. In some embodiments, a user device may be implemented in various objects such as appliances, vehicles, meters, or other objects. In some embodiments, one or more of the user devices 102A-102D may, at one time or another, act as a relay, base station, (e.g., a UAV acting as an aerial base station), or the network equipment (e.g., macro eNBs or gNBs, small cell eNBs or gNBs, or relay base stations). As such, in some embodiments, one or more signals transmitted from the unit, station, terminal, client, wireless local loop station, IoT device, Internet of Everything device, machine type communication device, evolved or enhanced machine type communication device, user device implemented in an object, another type of user device, or one or more combinations thereof, can be received by the multi-network management system 130 (e.g., through network managers 116A-116C).

Coverage area 110A can provide services from network 108, such as network provider services including the Internet, Intranet, Internet Protocol Multimedia Subsystem, Packet-Switched Streaming Service, another type of network provider service, or one or more combinations thereof. In embodiments, one or more of the user devices 102A-102D, base stations 114A-114F, satellites 120A-120B, multi-network management system 130, or one or more combinations thereof, can be configured to support ultra-reliable communications, low-latency communications, mission critical communications, ultra-reliable low-latency communications, ultra-reliable functions, low-latency functions, critical functions, mission critical push-to-talk functions, mission critical video functions, other types of communications, or one or more combinations thereof, associated with the multi-network management system 130. In addition, the multi-network management system 130 may receive or transmit signals corresponding to a network provider service (e.g., Internet, Intranet, Internet Protocol Multimedia Subsystem, Packet-Switched Streaming Service).

In embodiments, one or more of the multi-network management system 130, base stations 114A-114F, satellites 120A-120B, or one or more combinations thereof, can communicate with the telecommunications network 108 via a core network, one or more network components (e.g., a core network node, a relay device, an MME, an integrated access and backhaul node, a macro eNB, a small cell eNB, a gNB, a relay base station), or one or more combinations thereof. In some embodiments, one or more of base stations 114A-114F, satellite 120A, satellite 120B, or one or more combinations thereof, communicate with the telecommunications network 108 over one or more backhaul links (e.g., via an X2, Xn, or other interface) either directly (e.g., directly between base stations), or indirectly (e.g., via core network), or one or more combinations thereof. The backhaul links may be or include one or more wireless links, for example.

In embodiments, RAN nodes including base stations 114A-114F may operate using MIMO transmissions. For example, one or more of the RAN nodes including base stations 114A-114F can be configured as FD-MIMO, massive MIMO, MU-MIMO, cooperative MIMO, 4G, 5G, another generation communication system, or one or more combinations thereof, for providing telecommunication services to one or more of user devices 102A-102D. In embodiments, one or more of the RAN nodes including base stations 114A-114F can perform one or more of the following functions: transfer user data, radio channel ciphering and deciphering, integrity protection, header compression, mobility control functions (e.g., handover, dual connectivity), inter-cell interference coordination, connection setup and release, load balancing, distribution for a non-access stratum message or node selection, a synchronization, radio access network sharing, multimedia broadcast multicast service, subscriber and equipment trace, radio access network information management, paging, positioning, delivery of warning messages, other functions, or one or more combinations thereof. As such, one or more of the one or more of the RAN nodes including base stations 114A-114F can be associated with the FD-MIMO, massive MIMO, MU-MIMO, cooperative MIMO, 4G, 5G, another generation communication system, one or more of the corresponding functions of such system, or one or more combinations thereof.

In some embodiments, one or more RAN node antennas (or antenna arrays) having antenna elements may be co-located at an antenna assembly, such as an antenna tower. In some examples, antennas or antenna arrays associated with the RAN nodes including base stations 114A-114F can be located in diverse geographic locations. In embodiments, antenna elements of one or more antennas may each be within a threshold distance from at least one of the other antenna elements. In some aspects, one or more nodes corresponding to base stations 114A-114F may comprise one or more macro cells, one or more small cells, one or more relay base stations, one or more repeaters, one or more femtocells, other types of cells, or one or more combinations thereof. In other embodiments, one or more of the RAN nodes including base stations 114A-114F can be movable, thereby providing communication coverage for a moving geographic coverage area (e.g., coverage area 110D). In some embodiments, one or more antennas of RAN nodes including base stations 114A-114F can use MIMO antenna technology, including spatial multiplexing, beamforming, transmit diversity, other MIMO functions, or one or more combinations thereof.

In embodiments, one of more RAN nodes can include one or more of the satellites 120A-120B, which may communicate with other types of RAN nodes (e.g., the base stations 114A-114F, user devices 102A-102D, or other high altitude or terrestrial RAN nodes). “Satellite” may also be referred to as a space vehicle or communication satellite. Satellites 120A-120B may be any suitable type of communication satellite configured to relay communications between different RAN nodes or RAN end nodes in a wireless communication system. Satellites 120A-120B may be or include a space satellite, a balloon, a dirigible, an airplane, a drone, an unmanned aerial vehicle, another type of satellite, or one or more combinations thereof. In some examples, the satellites 120A-120B may be in a geosynchronous or geostationary earth orbit, a low earth orbit, a medium earth orbit, another type of orbit, or one or more combinations thereof. In some embodiments, satellites 120A-120B may be a multi-beam satellite configured to provide service for multiple service beam coverage areas in a predefined geographical service area (e.g., coverage area 110A). The satellites 120A-120B may be any distance away from the surface of the earth.

In some embodiments, satellites 120A-120B may be deployed at an altitude of 18 km to 25 km (e.g., a geostationary balloon satellite), wherein the stratosphere has low wind speeds (e.g., 5 m/s to 40 m/s) and low turbulence. In embodiments, satellites 120A and 120B may be configured to communicate with each other (e.g., via communication link 126). As such, the communication link 126 may include a free space optical link, a microwave link, electromagnetic wave signals via mm wave signals, optical signals via a laser, another type of communication link, or one or more combinations thereof. In embodiments, satellites 120A-120B may be configured to communicate via a wireless common public radio interface protocol, a dedicated wireless front haul protocol developed for high-altitude-to-high-altitude, another protocol, or one or more combinations thereof. As such, in some embodiments, the network performance data corresponding to satellite 120A or 120B and received by multi-network management system 130 may correspond to a measurement of the free space optical link, microwave link, electromagnetic wave signals via mm wave signals, optical signals via laser, wireless common public radio interface protocol, a dedicated wireless front haul protocol developed for high-altitude-to-high-altitude, the other type of communication link, or one or more combinations thereof.

In some embodiments, one or more portions of coverage area 110A (e.g., encompassing coverage areas 110B-110E) may be provided or established by satellites 120A-120B as part of a non-terrestrial network. Satellites 120A-120B may, in some cases, perform the functions of a base station or may act as a bent-pipe satellite, act as a regenerative satellite, act as another type of satellite, or one or more combinations thereof. In other cases, satellites 120A-120B may be a smart satellite, or a satellite with intelligence. For example, a smart satellite may be configured to perform more functions than a regenerative satellite (e.g., may be configured to perform particular algorithms beyond those used in regenerative satellites or to be reprogrammed, for example). A bent-pipe transponder or satellite may be configured to receive signals from ground base stations (e.g., base stations 114A-114F) and transmit those signals to different ground base stations. In some embodiments, a bent-pipe transponder or satellite may amplify signals or shift from uplink frequencies to downlink frequencies. A regenerative transponder or satellite may be configured to relay signals like the bent-pipe transponder or satellite, but may also use on-board processing to perform other functions. Examples of these other functions may include demodulating a received signal, decoding a received signal, re-encoding a signal to be transmitted, or modulating the signal to be transmitted, another type of satellite or regenerative transponder function, or one or more combinations thereof. For example, a bent-pipe satellite may receive a signal from a base station and may relay the signal to a user device or base station, or vice-versa. As such, in some embodiments, the multi-network management system 130 can receive the network performance data associated with one or more of these types of satellites (e.g., bent-pipe satellite, regenerative satellite, smart satellite, other type of satellite, or one or more combinations thereof). In some embodiments, the network performance data corresponds to the demodulated signal, decoded signal, re-encoded signal, modulated signal, another type of satellite or regenerative transponder function, or one or more combinations thereof.

Multi-network management system 130 can be configured to communicate with network managers 116A-116C, as well as other network managers or other network components across a plurality of various geographical regions and coverage areas. In some embodiments, the multi-network management system 130 can be located in a core network corresponding to network 108. The multi-network management system 130 can analyze network performance data, provide trigger event determinations and localization, determine network performance data outliers, other types of determinations, end-to-end optimization for RAN nodes within a plurality of coverage areas, and transmit RAN node operation instructions, as well as alerts, notifications, and recommendations associated with particular RAN nodes within a plurality of coverage areas. In some embodiments, the multi-network management system 130 can transmit interface self-configuration and optimization. In some embodiments, the multi-network management system 130 can shift one or more operations or one or more loads between network domains corresponding to the network managers 116A-116C and based on receiving the network performance data from each of the network managers 116A-116C. For example, the multi-network management system 130 can allocate various resources or resource usages corresponding to the plurality of RAN nodes within a plurality of coverage areas. In some embodiments, the multi-network management system 130 can be integrated with operations support systems or customer experience management tools corresponding to each of the network managers 116A-116C. In some embodiments, the multi-network management system 130 can connect to one or more transport provisioning tools (e.g., a software defined networking controller) of the network managers 116A-116C via a standard measurement and configuration interface or can act as a user of one or more of the transport provisioning tools.

In some embodiments, each of network managers 116A-116C are above a threshold distance from each other. In some embodiments, one or more of the network managers 116A-116C include self-organizing network technology that can apply true plug-and-play, self-configuration, and self-optimization. In some embodiments, one or more of the network managers 116A-116C are deployed at an eNB, a signaling gateway, or a system architecture evolution gateway. For example, the network manager 116A can be a software entity running on the eNB or attached to the eNB as a site device. As another example, the network manager 116A can configure transport connectivity of base station 114A and base station 114B. In some embodiments, the network managers 116A-116C can extract real-time quality of experience and QoS measurements (e.g., one or more KPIs) from control plane traffic of the base station 114A and 114B. In some embodiments, one or more of the network managers 116A-116C can implement a closed control loop.

In embodiments, the multi-network management system 130 can receive network performance data (e.g., from network managers 116A-116C) corresponding to one or more of user devices 102A-102D, the base stations 114A-114F, satellites 120A-120B, another network component (e.g., an MME), or one or more combinations thereof. As one example, the network performance data can correspond to communications between user device 102D and base station 114D over coverage area 110D. As another example, the network performance data can correspond to communications between user device 102B and one or more of base stations 114E and 114F (or a handover between base stations 114E and 114F) over coverage area 110E. As another example, the network performance data can correspond to communications between user device 102C and one or more of base stations 114A and 114B (or a handover between base stations 114A and 114B) over coverage areas 110B or 110C. In another example, the network performance data can correspond to communications between user device 102C and satellite 120A, or a handover between satellite 120A and base station 114B.

In yet another example, the network performance data can correspond to an enhanced broadband communication, an ultra-reliable communication, a low latency communication, another type of communication, or one or more combinations thereof, within one or more portions of coverage area 110A. In some embodiments, the network performance data can correspond to a License Assisted Access communication, an LTE-Unlicensed radio access technology communication, an unlicensed band communication, a carrier sensing operation for collision avoidance and detection, a downlink transmission, an uplink transmission, a P2P transmission, a D2D transmission, another type of unlicensed spectrum operation, an FD-MIMO communication, a massive MIMO communication, an MU-MIMO communication, a cooperative MIMO communication, a 4G communication, a 5G communication, another generation communication, another type of communication, or one or more combinations thereof. In some embodiments, the network performance data can correspond to ultra-reliable communications, low-latency communications, mission critical communications, ultra-reliable low-latency communications, RAN node ultra-reliable functions, RAN node low-latency functions, RAN node critical functions, mission critical push-to-talk functions, mission critical imaging functions, another type of coverage area 110A device communication or function, or one or more combinations thereof.

In embodiments, one or more of the user devices 102A-102D, the base stations 114A-114F, satellites 120A-120B, the multi-network management system 130, another network component (e.g., an MME), or one or more combinations thereof, may have one or processors capable of processing network performance data (e.g., KPIs), user device location data, weather data (e.g., humidity data, ultraviolet data, temperature data), ultra-reliable data, low-latency data, critical data, other types of data, or one or more combinations thereof. In some embodiments, the multi-network management system 130 has one or more processors, which may include one or more of a system-on-a-chip, a processor core, a graphics processor unit, a central processing unit, an accelerator (e.g., a digital signal processor, a graphics accelerator, a compression accelerator, an artificial intelligence accelerator), a chipset processor, a general-purpose processor, a general-purpose graphics processor unit, an accelerated processing unit, a field-programmable gate array, a neural network processing unit, a data processor unit, a controller, another type of processor or processor unit, or one or more combinations thereof. In some embodiments, a processor unit of the multi-network management system 130 may be located in a single integrated circuit component (e.g., multi-chip module) or in separate integrated circuit components.

In embodiments, the one or more processors of the multi-network management system 130 can determine an trigger event for a first RAN node (e.g., base station 114A, satellite 120A, another network component of coverage area 110A, an antenna element or antenna array of base station 114C, an antenna element or antenna array of satellite 120B) of coverage area 110A based on the network performance data. In one non-limiting example, the one or more processors of multi-network management system 130 can analyze network performance data received in real-time, wherein the network performance data includes a first set of KPIs received during a first predetermined time range at a first predetermined rate, and wherein the KPIs correspond to one or more downlinks from base station 114C to user device 102C. Continuing this example, the KPIs can include measurements of the downlink by user device 102C (e.g., SINR). Additionally or alternatively, the KPIs can correspond to antenna elements of the base station 114C (e.g., antenna tilt and antenna angle).

In some embodiments, the multi-network management system 130 can determine a trigger event for a plurality of RAN nodes (e.g., base station 114D and base station 114F, satellite 120B and base station 114C, two or more network components of coverage area 110A, an antenna element of base station 114B and an antenna element of base station 114E, an antenna array of base station 114A and an antenna array of base station 114D) based on a trigger event threshold. For example, the trigger event for a RAN node can be determined based on a KPI received from the RAN node being above a threshold. In some embodiments, the threshold can correspond to one or more RAN nodes of a network manager (e.g., antenna arrays of base station 114A and network manager 116A). In some embodiments, the threshold can correspond to a capacity of one or more network managers (e.g., a capacity of the network manager 116B or a total capacity of each of network managers 116A-116C). In embodiments, the multi-network management system 130 can adjust an operation of the RAN node having the trigger event or manage the site configuration files for the RAN node having the trigger event or an adjacent RAN node.

FIG. 2 provides example operating environment 200 for supporting the multi-network management system 130, in accordance with one or more embodiments disclosed herein. Example environment 200 is but one example of a suitable environment for the multi-network management system 130 and the associated techniques disclosed herein, and is not intended to suggest any limitation as to the scope of use or functionality of the invention. Neither should the environment 200 be interpreted as having any dependency or requirement relating to any one or combination of components illustrated. For example, in some embodiments, the example operating environment 200 can include additional core networks or network managers not depicted.

Example operating environment 200 includes user devices 202A-202D; RAN network 204A including base station 214A having coverage area 210A, base station 214B having coverage area 210B, and base station 214C having coverage area 210C; RAN network 204B including base station 214D having coverage area 210D, base station 214E having coverage area 210E, and base station 214F having coverage area 210F; core network 220A having core network components 222 and 224; core network 220B having core network components 226 and 228; network manager 230A and network manager 230B; and multi-network management system 130. Example operational environment 200 is but one example environment for the multi-network management system 130. For example, another embodiment may include additional radio access networks and core networks.

In some embodiments, user devices 202A-202D are similar to user devices 102A-102D described herein with respect to FIG. 1 or similar to user device 500 described herein with respect to FIG. 5. For example, user devices 202A-202D may include a PC, a laptop computer, a tablet, a mobile phone, a PDA, a server, or any other device that is capable of communicating with other devices (e.g., by transmitting or receiving a signal) using a wireless communication. In some embodiments, base stations 214A-214F are similar to base stations 114A-114F described herein with respect to FIG. 1. For example, in some embodiments, one or more of the base stations 214A-214F can be configured as FD-MIMO, massive MIMO, MU-MIMO, cooperative MIMO, 4G, 5G, another generation communication system, or one or more combinations thereof, for providing telecommunication services to one or more of user devices 202A-202D.

In embodiments, one or more of core networks 220A-220B are an evolved packet core providing E-UTRAN features (e.g., a user plane packet data convergence, radio link control, medium access control, physical layer protocol, control plane radio resource control protocol). Core networks 220A-220B can provide user authentication, tracking, access authorization, Internet Protocol connectivity, and other access functions, other routing functions, or other mobility functions. In some embodiments, one or more of the core network components 222, 224, 226, 228 include an MME, a serving gateway, a packet data network gateway, another core network component, or one or more combinations thereof. In some embodiments, one or more of the core network components 222, 224, 226, 228 may perform one or more operations including an access and mobility management function, a session management function, a user plane function, a policy control function. In some embodiments, one or more of the core network components 222, 224, 226, 228 may include location management functions, MME functionality, serving gateway functionality (e.g., forwarding user data packets), packet data network gateway functionality, another type of core network component functionality, or one or more combinations thereof. In an example embodiment, core network component 222 is a serving gateway and is connected to core network component 224, which is a packet data gateway that can provide internet protocol address allocation. The core network 220A is connected to user devices 202A and 202B via RAN network 204A and the core network 220B is connected to user devices 202C and 202D via RAN network 204B.

In embodiments, network managers 230A-230B can provide network control and management features associated with user devices 202A-202D and associated user device location data. In some embodiments, the network managers 230A-230B are NetAct network managers. In some embodiments, the network managers 230A-230B trace incoming calls of the user devices 202A-202D, collect user device performance data from the user devices 202A-202D, track the location of the user devices 202A-202D via network operation control functions. In some embodiments, network manager 230A is a server with configuration files for base station 214A-214C to download, and network manager 230B is a server with configuration files for base station 214D-214F to download. In some embodiments, each of network managers 230A-230B maintains a database of serving gateways assigned to various tracking area codes. In embodiments, the network manager 230A can allocate a first bandwidth for the base station 214A to transmit that is associated with a value set as an average resource allocation based on base stations 214A-214C. In embodiments, the network manager 230A can provide commission data to base station 214B for the commissioning of an additional bandwidth to be transmitted by the base station 214B for coverage area 210B. The multi-network management system 130 can receive network performance data including KPIs for each of the RAN nodes, including base stations 214A-214F.

In some embodiments, the multi-network management system 130 can receive data from one or more of the RAN nodes that is indicative of one or more trigger events at the one or more RAN nodes. For example, a trigger event for a RAN node may refers to a specific occurrence or condition that prompts the multi-network management system 130 to initiate a series of operations aimed at managing and optimizing the RAN node's performance. These trigger events serve as triggers for automated processes, enabling proactive response to network changes, configuration updates, or other critical events such as processing, obtaining, and storing site configuration files for the one or more RAN nodes.

In one example, a trigger event may comprise network congestion. When the RAN experiences high levels of traffic or congestion, it can impact the quality of service provided to users. A trigger event may occur when predefined thresholds for network utilization, such as bandwidth or capacity, are exceeded. This event prompts the network manager to take action, such as load balancing, traffic prioritization, or adjusting resource allocation, to alleviate the congestion and ensure optimal network performance.

In one example, the trigger event may be one or more environmental changes. Changes in the surrounding environment can affect the RAN's performance. For instance, the introduction of new buildings, infrastructure, or natural obstacles like trees can impact signal propagation and coverage. A trigger event may be triggered by the detection of significant changes in signal strength, interference levels, or signal quality, prompting the network manager to adjust antenna configurations, transmission power, or perform site surveys to optimize coverage and minimize signal degradation. In other examples the environmental changes may be weather related issues, such as a severe thunderstorm watch or hurricane/tropical storm watch, which might be an indicator of an impending severe weather condition that could cause a loss of service or cause the RAN to go down.

In one example, the trigger event may be equipment failure or malfunction. In the event of equipment failure, such as a faulty base station or a malfunctioning component within the RAN, a trigger event is activated. The multi-network management system 130 detects the failure through various monitoring mechanisms and initiates corrective actions, such as rerouting traffic, switching to redundant equipment, or alerting maintenance personnel for immediate repairs. Prompt detection and resolution of equipment issues help maintain network reliability and minimize service disruptions.

In one example, the trigger event may be configuration updates such as updates to the site configuration files. When it becomes necessary to update the configuration settings of the RAN, a trigger event is triggered to initiate the update process. This can occur when new network features or standards are introduced, or when optimization measures are required to adapt to changing user demands or network conditions. The trigger event prompts the network manager to acquire the relevant site configuration data, create a new configuration file, and deploy it to the affected RAN nodes without overwriting previous configurations, ensuring a smooth transition and minimizing the risk of configuration errors.

The trigger event may also be related to a nearby RAN node occurring in the vicinity of the RAN node that prompts the multi-network management system 130 to take action. In one embodiment, the trigger event for a nearby RAN node may be interference detection. If a nearby RAN or wireless network starts causing interference on the operating frequencies of the RAN under consideration, a trigger event is activated. The multi-network management system 130 detects the interference through KPI monitoring mechanisms or signal analysis tools, and takes appropriate measures to mitigate the interference. This could involve adjusting transmission parameters, optimizing antenna positioning, or coordinating frequency usage with the nearby RAN to minimize the impact on network performance.

In one embodiment, the trigger event for a nearby RAN node may be spectrum availability. Changes in spectrum availability or allocation near the RAN node can trigger a trigger event. For instance, if a regulatory authority assigns new frequency bands or modifies the spectrum usage rules, the multi-network management system 130 must adjust the RAN node's configuration accordingly. The trigger event prompts the network manager to acquire information about the updated spectrum allocation and reconfigure the RAN to ensure compliance and optimal spectrum utilization.

In one embodiment, the trigger event for a nearby RAN node may be capacity demands. Increased capacity demands in the vicinity of the RAN node or a nearby RAN node, such as a sudden surge in user traffic or the deployment of new services, can trigger a trigger event. The network manager analyzes the capacity requirements and dynamically adjusts the RAN node's configuration to accommodate the increased demand. This may involve activating additional sectors, adjusting resource allocation, or optimizing the network parameters to maintain satisfactory user experience and service quality.

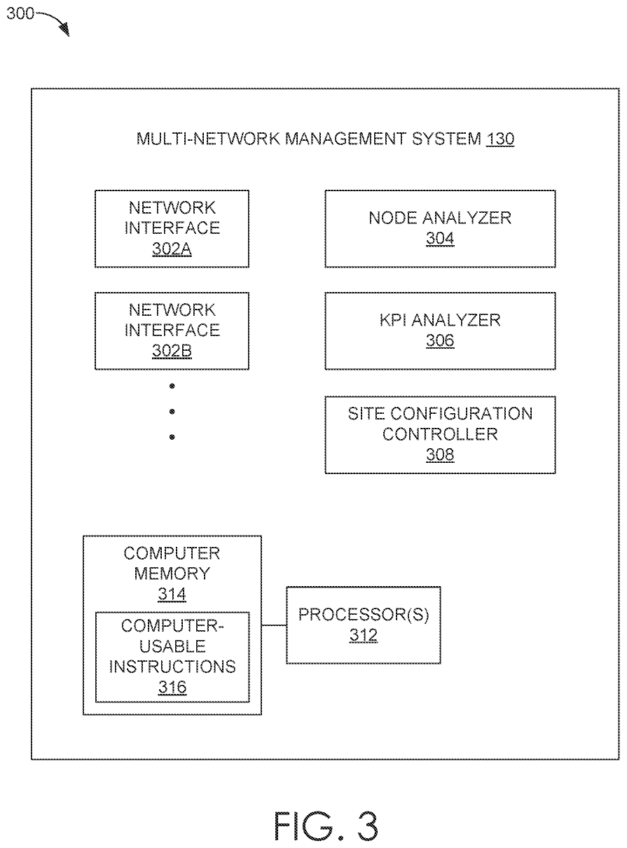

FIG. 3 includes example operating environment 300 for the multi-network management system 130. Example environment 300 is but one example of a suitable environment for the multi-network management system 130 and the associated techniques disclosed herein, and is not intended to suggest any limitation as to the scope of use or functionality of the invention. Neither should the environment 300 be interpreted as having any dependency or requirement relating to any one or combination of components illustrated. For example, in some embodiments, the example operating environment 300 can include additional processors not depicted. As another example, the node analyzer 304 and the KPI analyzer 306 can be part of the same analyzer.

Example operating environment 300 of the multi-network management system 130 includes network interface 302A, network interface 302B, node analyzer 304, capacity analyzer 306, site configuration controller 308, processor(s) 312, and computer memory 314 having computer usable instructions 316.

Network interfaces 302A and 302B, in some embodiments, can be used for communicating with one or more external databases, one or more core networks, one or more network managers, one or more user devices, one or more RAN nodes, one or more radio access networks, one or more other servers, one or more satellites, one or more other devices corresponding to the radio access network, or one or more combinations thereof. In some embodiments, one or more of network interfaces 302A and 302B include NetWork Interface V3 or a common object request broker architecture. For example, the multi-network management system 130 can receive network performance data corresponding to a first radio access network via network interface 302A and network performance data corresponding to a second radio access network via network interface 302B.

In some embodiments, the multi-network management system 130 receives KPIs from each of a plurality of radio access networks that each have a plurality of RAN nodes. In some embodiments, the KPIs received include one or more KPI types. The five tables provided below include several non-exhaustive example KPI types:

TABLE 1
KPIs for the GSM network

| | Key | | | |
|---|---|---|---|---|
| | performance | | | |
| KPI | indicators | | Measurement | |
| category | (KPIs) | Definition | approach | Considerations |
| Availability | Radio | Mobile coverage can | Theoretical | This parameter can |
| | coverage- | represents the strength or | calculation or | measure the |
| | RxLev | power level of signal or | Drive test | geographic reach of |
| | | reception in a given area in | | a mobile GSM |
| | | which a user device can | | network. |
| | | have access to both data | | |
| | | and voice services (e.g., | | |
| | | radio coverage | | |
| | | measurements [ITU-T | | |
| | | E.806]). | | |
| Accessibility | Stand-alone | The proportion of user | Real traffic | Secondary |
| | dedicated | devices which successfully | | This KPI can indicate |
| | control | access resources, having | | accessibility for |
| | channel | requested an appropriate | | several procedures like |
| | (SDCCH) | service on accessing the | | call setup, SMS |
| | assignment | SDCCH (e.g., clause 5.6 of | | delivery and location |
| | success rate | [b-ETSI TR 32.814]). | | update and can also be |
| | | | | used to troubleshoot |
| | | | | circuit switch (CS) |
| | | | | access issues. |
| | Stand-alone | The proportion of all | Real traffic | Secondary |
| | dedicated | SDCCH resource requests | | This KPI can indicate |
| | control | and failed due to no | | accessibility for |
| | channel | SDCCH resource available | | several procedures in |
| | (SDCCH) | (e.g., clause 5.7 of | | circuit service. It can |
| | congestion | [b-ETSI TR 32.814]). | | show the status of the |
| | | | | SDCCH resource |
| | | | | utilization. It can also |
| | | | | show resource |
| | | | | dimensions. When |
| | | | | SDCCH is highly |
| | | | | congested, TCH |
| | | | | utilization can |
| | | | | degrade. |
| | Traffic | The proportion of all | Real traffic | Primary |
| | channel | requests for TCH resources | | TCH congestion often |
| | (TCH) | (call origination and | | increases when traffic |
| | congestion | incoming handover) and | | demand increases. |
| | | fail due non available TCH | | |
| | | resources (e.g., clause 5.8 | | |
| | | of | | |
| | | [b-ETSI TR 32.814]). | | |
| | Call setup | Measures the proportion of | Real traffic or | Primary |
| | success rate | user devices which | test traffic | The preceding KPIs on |
| | | successfully access a TCH | | SDCCH and TCH are |
| | | (e.g., clause 5.5 of | | sub KPIs of Call Setup |
| | | [b-ETSI TR 32.814]). | | Success Rate. |
| | | | | Any of the |
| | | | | TCH/SDCCH KPIs |
| | | | | listed above can |
| | | | | impact the call setup |
| | | | | success rate. Call setup |
| | | | | success rate gives an |
| | | | | overview of a call, |
| | | | | from initiation to |
| | | | | setup. |
| | Packet data | Describes the ratio of all | Real traffic or | Secondary |
| | protocol | successful PDP context | test traffic | Before data is |
| | (PDP) context | activation to PDP context | | transferred to and from |
| | activation | activation attempts (e.g., | | a base station, a PDP |
| | success rate | clause 7.5 of | | context can be |
| | | [ETSI TS 132 410]). | | activated. With a low |
| | | | | or worse PDP context |
| | | | | activation, access to |
| | | | | data could be a |
| | | | | challenge. |
| Retainability | Traffic | The proportion of user | Real traffic or | Primary |
| | channel | devices which, having | test traffic | TCH drop can be |
| | (TCH) drop | successfully accessed the | | perceived by a user as |
| | rate | TCH, subsequently suffer | | it directly translates to |
| | | an abnormal release (e.g., | | call drop. |
| | | clause 5.3 of | | |
| | | [b-ETSI TR 32.814]). | | |
| | Handover | The percent of handovers | Real traffic or | Secondary |
| | success rate | that were attempted from | test traffic | Handover can |
| | | the source cell (cell for | | guarantee call |
| | | which the statistic is | | continuity and can |
| | | presented) that succeeded in | | indicate influencing |
| | | making it to the destination | | factors that include |
| | | cell (e.g., clause 5.4 of | | among other things, |
| | | [b-ETSI TR 32.814]). | | congestion, coverage, |
| | | | | interference, and |
| | | | | clocking problems. |
| | | | | A poor/low handover |
| | | | | success rate could |
| | | | | influence other KPIs |
| | | | | (e.g., TCH drop). |

TABLE 2
Example KPIs for UMTS Network

| | Key | | | |
|---|---|---|---|---|
| | performance | | | |
| | indicators | | Measurement | |
| Category | (KPIs) | Definition | approach | Considerations |
| Availability | Radio coverage- | User device coverage can | Theoretical | This parameter can |
| | Received signal | represent the RSCP level | calculation or | estimate the |
| | code power | of signal or reception in a | Drive test | geographic reach of a |
| | (RSCP) | given area in which a user | | mobile UMTS |
| | | device can have | | network. |
| | | successfully access both | | |
| | | for data and voice services | | |
| | | (e.g., [ITU-T E.806]). | | |
| Accessibility | Circuit switch | Describes the ratio of all | Real traffic or | Primary |
| | (CS) radio | successful RRC | test traffic | This KPI can indicate |
| | resource control | establishments to RRC | | the signalling |
| | (RRC) setup | establishment attempts | | functions that |
| | success rate | (e.g., clause 7.2 of [ETSI | | configures the UE and |
| | | TS 132 410]). | | control planes to allow |
| | | | | other functions (e.g., |
| | | | | calls, handover, etc.) |
| | | | | and resource |
| | | | | management to be |
| | | | | implemented. This |
| | | | | KPI can be used for |
| | | | | troubleshooting and |
| | | | | dimension purposes. It |
| | | | | can be used to |
| | | | | determine RNC or cell |
| | | | | admission capacity or |
| | | | | system load. |
| | Radio access | The ratio of successful | | Primary |
| | bearer (RAB) | conversational speech | | Can be used to |
| | establishment | related RAB | | evaluate speech |
| | success rate for | establishments to | | service accessibility. |
| | circuit switch | conversational speech | | This KPI can be used |
| | (CS) | related RAB | | to determine planning |
| | | establishment attempts | | and dimension, speech |
| | | (e.g., clause 7.1.1 of | | calls redirected to gsm, |
| | | [ETSI TS 132 410]). | | or calls unto the 3G |
| | | | | network via incoming |
| | | | | IRAT handover. |
| | Radio access | Describes the ratio of all | | Primary |
| | bearer (RAB) | successful PS RAB | | |
| | establishment | establishments to PS | | |
| | success rate for | related RAB | | |
| | packet switch | establishment attempts | Real traffic | Can be used to |
| | (PS) | (e.g., clause 7.1 of [ETSI | | evaluate packet-based |
| | | TS 132 410]). | | service accessibility. |
| Retainability | Radio access | Describes the ratio of | Real traffic or | Primary |
| | bearer (RAB) | number of RAB release | test traffic | Any RAB abnormal |
| | abnormal release | requests to number of the | | release after RAB |
| | rate | successful RAB | | establishment and |
| | | establishments (e.g., | | alerting can be |
| | | clause 8.1 of [ETSI TS | | considered a drop call. |
| | | 132 410]). | | |
| | Soft handover | Describes the ratio of | Real traffic or | Secondary |
| | success rate | number of successful | test traffic | Measures the |
| | | radio link additions to the | | simultaneous |
| | | total number of radio link | | establishment of links |
| | | addition attempts (e.g., | | to two base stations. It |
| | | clause 9.1 of | | can indicate that this |
| | | [ETSI TS 132 410]). | | handover success is |
| | | | | high because issues |
| | | | | can result in a dropped |
| | | | | call. |
| | Circuit switch | Describes the ratio of | Real traffic or | Secondary |
| | (CS) inter radio | number of successful inter | test traffic | This KPI can be used |
| | access | RAT handover to the total | | to evaluate whether |
| | technology | number of the attempted | | the capacity on the cell |
| | (RAT) handover | inter RAT handover from | | (i.e., on the GSM |
| | success rate | UMTS to GSM for CS | | network) that the UE |
| | | domain (e.g., clause 9.3 of | | is trying to enter for |
| | | [ETSI TS 132 410]). | | CS may be insufficient |
| | | | | or not. |
| | | Describes the ratio of | | Secondary |
| | | number of successful inter | | This KPI can be used |
| | | RAT handover to the total | | to evaluate whether |
| | | number of the attempted | | |
| | | inter RAT handover from | | |
| | | UMTS to GSM for PS | | |
| | Packet switch | domain (e.g., clause 9.4 of | Real traffic or | the capacity on the cell |
| | (PS) inter RAT | [ETSI TS 132 410]). | test traffic | (i.e., on the GSM |
| | handover success | | | network) that the UE |
| | rate | | | is trying to enter for |
| | | | | PS may be insufficient |
| | | | | or not. |

TABLE 3
Example KPIs for LTE Network

| | Key | | | |
|---|---|---|---|---|
| | performance | | | |
| | indicators | | Measurement | |
| Category | (KPIs) | Definition | approach | Considerations |
| Availability | Radio coverage- | Mobile coverage | Theoretical | This parameter is |
| | RSRP reference | essentially represents | calculation/ | important for the |
| | signal received | the strength/power level | Drive test | estimation of the |
| | power | of signal or reception in | | geographic reach of a |
| | | a given area in which an | | mobile LTE network. |
| | | end user can have | | |
| | | successfully access both | | |
| | | for data and voice | | |
| | | services (e.g., | | |
| | | [ITU-T E.806]). | | |
| Accessibility | E-UTRAN radio | Probability for an end- | Real traffic | Primary |
| | access bearer (E- | user to be provided with | or test traffic | It is a major KPI in LTE |
| | RAB) | an E-RAB at request | | for measuring |
| | accessibility | (e.g., clause 6.1.1 of | | accessibility. For the |
| | | [ETSI TS 132 450]). | | purposes of optimisation, |
| | | | | it helps understand the |
| | | | | common failures that |
| | | | | usually cause E-RAB |
| | | | | setup failures. |
| | Evolved-UMTS | A measurement that | | Primary |
| | terrestrial radio | shows how often an | | E-RAB is an important |
| | access network | end-user abnormally | | parameter in LTE KPI |
| | (E-UTRAN) | loses an E-RAB during | | analysis. An E-RAB |
| | Radio access | the time the E-RAB is | | abnormal release means |
| Retainability | bearer (E-RAB) | used (e.g., clause 6.2.1.2 | Real traffic | that an ongoing session is |
| | abnormal release | of [ETSI TS 132 450]). | or test traffic | dropped requiring the user |
| | rate | | | to initiate a new |
| | | | | connection to resume the |
| | | | | services. |
| Integrity | Latency | A measurement | Test traffic | Primary |
| | | that shows how | | Latency impacts the |
| | | E-UTRAN impacts on | | network's throughput and |
| | | the delay experienced | | thus the user's experience. |
| | | by an end-user. Time | | The higher the latency, |
| | | from reception of IP | | the higher the delays and |
| | | packet to transmission | | the poorer the user's |
| | | of first packet over the | | experience |
| | | air interface (e.g., clause | | |
| | | 6.3.2 of [ETSI TS 132 | | |
| | | 450]). | | |

TABLE 4
Example KPIs for LTE Network

| LTE KPI | Test Case |
|---|---|
| Accessibility | RRC Connection Establishment |
| | Random Access |
| | Initial E-RAB Establishment Success Rate |
| | RRC Connection Establishment Counters |
| | Initial E-RAB Establishment Success Rate Counters |
| | Added E-RAB Establishment Success Rate Counters |
| | Added E-RAB Establishment Success Rate |
| | S1 Signaling Connection Establishment |
| Retainability | MME Initiated E-RAB & UE Context Release with |
| | counters Description |
| | UE Session Time |
| | RBS Initiated E-RAB & UE Context Release with |
| | counters Description |
| | MME & RBS Initiated UE Context Release Flow |
| | Chart |
| | MME & RBS Initiated E-RAB Release Flow Chart |
| Integrity | E-UTRAN Throughput KPIs |
| | E-UTRAN Latency KPIs |
| | E-UTRAN Packet Loss KPIs |
| Mobility | X2 Based Handover Preparation & Execution |
| | Intra RBS Handover Preparation & Execution |
| | Intra Frequency Handover Preparation & Execution |
| | Counters |
| | S1 Based Handover Preparation & Execution |
| | Intra-frequency intra-LTE S1 & X2 Handover |
| | Flowchart |
| | Inter Frequency Handover Preparation & Execution |
| | Counters |
| | Inter-frequency intra-LTE S1 & X2 Handover |
| | Flowchart |
| Availability | Partial cell availability (node restarts excluded) |

TABLE 5
Example KPIs for 5G Network

| 5G performance | | |
|---|---|---|
| requirement type | Minimum KPI requirement | category |
| Peak Data Rate | Downlink: 20 Gbps | eMBB |
| | Uplink: 10 Gbps | |
| Peak Spectral Efficiency | Downlink: 30 bits/sec/Hz | eMBB |
| | Uplink: 15 bits/sec/Hz | |
| Data rate experienced by | Downlink: 100 Mbps | eMBB |
| User | Uplink: 50 Mbps | |
| Area Traffic Capacity | Downlink: 10 Mbits/sec/m² | eMBB |
| | in indoor hotspot | |
| | (eMBB test environment) | |
| Latency (User Plane) | 4 ms for eMBB | eMBB, |
| | 1 ms for URLLC | URLLC |
| Latency (User Plane) | 20 ms | eMBB, |
| | (10 ms encouraged) | URLLC |
| Connection Density | 1 × 10⁶ devices/Km² | mMTC |
| Average Spectral | (All the below figures are in | eMBB |
| Efficiency | units of bits/sec/Hz/TRxP) | |
| | Indoor hotspot: DL: 9/UL: 6.75 | |
| | Dense Urban: DL: 7.8/UL: 5.4 | |
| | Rural: DL: 3.3/UL: 1.6 | |
| Energy Efficiency | Efficient data transmission | eMBB |
| | (Loaded case): | |
| | To be demonstrated by | |
| | “average spectral | |
| | efficiency”. | |
| | Low energy consumption | |
| | (no data case): | |
| | This test case should | |
| | support high sleep | |
| | ratio/long sleep duration. | |
| Reliability | 1 × 10⁻⁵ probability of | URLLC |
| | transmitting layer-2 | |
| | Power Distribution Unit | |
| | (PDU) of 32 bytes | |
| | in size within 1 ms | |
| | (in channel quality of | |
| | coverage edge for Urban | |
| | Macro-URLLC test | |
| | environment.) | |
| Mobility | Dense Urban: up to 30 Km/h | eMBB |
| | Rural: up to 500 Km/h | |
| Mobility Interruption | 0 ms | eMBB, |
| Time | | URLLC |
| Bandwidth (Maximum | At least 100 MHz | IMT-2020 |
| Aggregated System) | Up to 1 GHz for operation | |
| | in high frequency | |
| | bands i.e. above 6 GHz | |

The multi-network management system 130 can receive one or more of the example KPIs in the tables above, or one or more combinations of these example KPIs. Additionally, the multi-network management system 130 can process each KPI received (e.g., via network interface 302A or network interface 302B) using one or more processors 312 via the computer readable memory 314 and the computer-usable instructions. For example, the node analyzer 304 can determine that one or more RAN nodes have a trigger event occurrence. The node analyzer 304 analyzes incoming data and events to determine the occurrence of a trigger event. Trigger events can include network congestion, environmental changes, equipment failure, or configuration update requirements. In some embodiments, the node analyzer 304 can determine a first RAN node of a first radio access network has data that are indicative of a trigger event. The node analyzer 304 is responsible for collecting and analyzing data from individual RAN nodes, such as base stations or access points. The node analyzer 304 acts as an intelligent monitoring tool that provides insights into the performance, health, and operational parameters of each node in the network.

In other embodiments the node analyzer 304 continuously monitor and gather data from RAN nodes in real-time. This includes collecting information about signal strength, signal quality, interference levels, traffic load, and other KPIs specific to the RAN node. The node analyzer 304 utilizes various monitoring techniques, such as data sampling, probing, or network monitoring protocols, to retrieve relevant data from the nodes.

Once the data is collected, the node analyzer 304 performs analysis and processing to derive meaningful insights and actionable information. It evaluates the collected KPIs and compares them against predefined thresholds or performance benchmarks. This analysis helps identify potential issues or deviations from expected performance levels, enabling network operators to take appropriate corrective actions.

The node analyzer 304 also plays a vital role in fault detection and troubleshooting. It can detect anomalies, equipment failures, or deviations in performance indicators, triggering alarms or notifications for network operators. This enables prompt investigation and resolution of issues, minimizing downtime and improving overall network reliability.

The KPI analyzer 306 evaluates and analyzes performance metrics and indicators across the network. It gathers data from various RAN nodes, aggregates and processes the information, and provides comprehensive insights into the overall performance and efficiency of the network.

The KPI analyzer 306 collects a wide range of performance data from RAN nodes, including metrics related to network capacity, coverage, latency, call quality, handover success rate, and other performance-related aspects. It consolidates this data from multiple nodes and analyzes it to identify trends, patterns, and anomalies that impact network performance.

The KPI analyzer 306 employs various statistical and analytical techniques to derive meaningful insights from the collected data. It can generate reports, visualizations, or dashboards that provide network operators with a comprehensive overview of network performance and identify areas for optimization or improvement.

By closely monitoring KPIs, the KPI analyzer 306 assesses the overall health of the network, identify potential bottlenecks or areas of congestion, and optimize resource allocation. KPI analyzer 306 tracks network performance over time, compare KPIs against service-level agreements (SLAs) or industry benchmarks, and make informed decisions to enhance the quality of service and user experience.

Furthermore, the KPI analyzer 306 provides capacity planning and optimization. By analyzing KPIs related to network utilization, traffic patterns, or resource allocation, it helps operators identify areas where additional capacity is required or where optimization measures can be implemented to ensure efficient resource utilization and improved network performance.

When a trigger event happens, the KPI analyzer is able to identify it in the KPIs as significant changes or abnormalities. For example, network congestion may cause a sudden increase in latency or a decrease in call quality. Environmental changes like severe weather conditions might result in fluctuating signal strength or increased interference levels. Equipment failures could lead to a drop in coverage or a sudden decrease in handover success rate.

By analyzing historical data and current KPI trends, the KPI analyzer 306 can identify deviations from expected performance levels. It applies statistical algorithms, data modeling, and pattern recognition techniques to distinguish between normal fluctuations and significant events that require attention which are trigger events

When a trigger event is detected, the KPI analyzer 306 can generate alerts, notifications, or alarms to notify network operators or system administrators. These alerts provide actionable information, indicating the specific trigger event and the affected areas within the RAN.

The site configuration controller is a critical component of the RAN management system that operates based on the identification of trigger events. It is designed to extract the current site configuration file from the affected RAN node and save it without overwriting the existing file, ensuring the preservation of valuable previous configurations.

Once the KPI analyzer 306 identifies a trigger event, the site configuration controller 308 initiates the process of retrieving the current site configuration file associated with the affected RAN node. It communicates with the RAN node and extracts the relevant configuration data, which includes information about physical site parameters, network settings, device configurations, and other related parameters.

Unlike traditional approaches that overwrite the entire site configuration file during updates, the site configuration controller 308 takes a more efficient approach. The site configuration controller 308 creates a new configuration file that incorporates the extracted current configuration data. This ensures the preservation of the previous site configuration file, which may contain valuable settings or optimizations that are crucial for maintaining network performance.

By saving the extracted current site configuration file separately, the site configuration controller enables seamless updates and minimizes the risk of disruptions or misconfigurations. It provides a backup of the previous configuration, allowing for easy rollback if necessary. This ensures that the RAN can be quickly reverted to a known stable configuration in case of unexpected issues or undesired consequences arising from the update process. The site configuration controller 308 maintains a versioning system that keeps track of the different configuration files associated with each trigger event. The trigger event causes a sequence of events that includes the retrieval of site configuration file information and the creation of a new site configuration file.

The site configuration controller 308 operates based on the identification of trigger events to extract the current site configuration file from the affected RAN node. The site configuration controller saves the extracted file separately without overwriting the existing configuration. The site configuration controller 308 ensures the preservation of valuable previous configurations and facilitates seamless updates while minimizing the risk of disruptions.

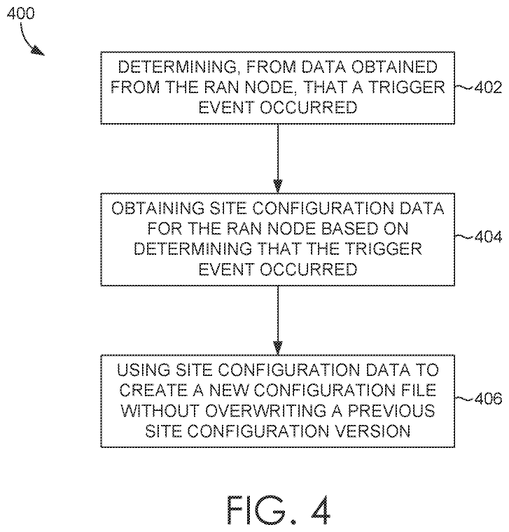

FIG. 4 includes example flowchart 400 for utilizing the multi-network management system. For example, Step 402 includes the multi-network management system determining, from data obtained from the RAN node that a trigger event has occurred. The system, which may have various components described previously, continuously collects and monitors a wide range of data from the RAN node, including network statistics, performance metrics, operational parameters, and environmental factors. The data obtained from the RAN node serves as the primary source for detecting trigger events.

Additionally, the system may consider the correlation and impact of multiple data parameters to validate the occurrence of a trigger event. It looks for consistent and concurrent deviations across different performance indicators to ensure accurate identification. For instance, if there is a sharp increase in latency accompanied by a decrease in call quality and a rise in network congestion, the system may infer that a trigger event, such as network overload, has taken place.

In other embodiments, the system may employ machine learning techniques or data-driven algorithms that learn from historical data and adaptively refine the trigger event detection process. The system may continually update its knowledge base and models based on real-time feedback and analysis, improving its ability to distinguish between normal network variations and true trigger events.

At Step 404, the multi-network management system extracts site configuration data from the RAN node, based on determining that a trigger event has occurred. In some embodiments, once the system identifies the trigger event through data analysis, it initiates the extraction process to obtain the relevant site configuration data from the affected RAN node.

The system establishes a secure and communicative connection with the RAN node, enabling it to retrieve the current site configuration file. It utilizes various protocols, APIs, or interfaces specific to the RAN node to access the configuration data. This data includes vital information about the physical site parameters, network settings, device configurations, and other relevant parameters that define the operational characteristics of the RAN node.

To ensure accuracy and completeness, the system may employ robust data retrieval mechanisms that verify the integrity of the retrieved site configuration data. It performs checksum validations, data consistency checks, or other verification techniques to ensure the reliability and authenticity of the extracted information.

At step 406, the system creates a new configuration file that incorporates the extracted site configuration data. By doing so, the system preserves the valuable previous configurations that may contain optimized settings or specific network parameters critical for maintaining the desired performance levels. The extracted site configuration data is saved separately, often with a unique identifier or versioning system, to ensure traceability and facilitate easy rollback if necessary. This approach enables seamless updates and mitigates the risk of disruptions or misconfigurations during the update process.

In one embodiment the system includes a data aggregation module that collects performance data from multiple RAN nodes, enabling a comprehensive analysis of network-wide performance. The statistical analysis module examines the aggregated data to identify trends, patterns, and anomalies, providing valuable insights for network optimization. The visualization module generates reports, visualizations, or dashboards that present the analyzed performance data in a user-friendly manner, facilitating data-driven decision-making for network operators and administrators.

In a further embodiment, the trigger event is identified based on a combination of multiple key performance indicators (KPIs) exceeding predefined thresholds either simultaneously or sequentially. This claim recognizes that trigger events often involve the co-occurrence or sequential occurrence of deviations in multiple KPIs. By considering the interplay between various performance metrics, the system enhances the accuracy of trigger event detection, ensuring that significant events are not overlooked.

In additional embodiments incorporates a backup module that securely stores previous site configuration files for historical reference and easy rollback. The versioning system enables the tracking of different configuration files associated with each trigger event, facilitating traceability and audit trails. Furthermore, the validation mechanism ensures the integrity and authenticity of the extracted site configuration data, verifying its accuracy before saving it separately without overwriting the existing file.

In an additional embodiment, the system includes a notification module that sends alerts, notifications, or alarms to network operators or system administrators upon detecting a trigger event. This feature enables prompt and proactive response to trigger events, ensuring timely awareness and intervention. Additionally, the communication interface provided by the network manager facilitates seamless communication and coordination between the different components of the system, such as the node analyzer, KPI analyzer, and site configuration controller, ensuring smooth operation and optimal management of the RAN.

In yet another embodiment the system employs the use of machine learning techniques or data-driven algorithms by the node analyzer and KPI analyzer. By continually learning from historical data and adapting to real-time feedback, these analyzers enhance their ability to accurately detect trigger events. This adaptive approach improves the system's effectiveness over time, as it becomes more proficient in distinguishing between normal network variations and actual trigger events.

Having described the example embodiments discussed above of the presently disclosed technology, an example operating environment of an example user device (e.g., user device 102A of FIG. 1) is described below with respect to FIG. 5. User device 500 is but one example of a suitable computing environment, and is not intended to suggest any particular limitation as to the scope of use or functionality of the technology disclosed. Neither should user device 500 be interpreted as having any dependency or requirement relating to any particular component illustrated, or a particular combination of the components illustrated in FIG. 5.

As illustrated in FIG. 5, example user device 500 includes a bus 502 that directly or indirectly couples the following devices: memory 504, one or more processors 506, one or more presentation components 508, one or more input/output (I/O) ports 510, one or more I/O components 512, a power supply 514, and one or more radios 516.

Bus 502 represents what may be one or more busses (such as an address bus, data bus, another type of bus, or one or more combinations thereof). Although the various blocks of FIG. 5 are shown with lines for the sake of clarity, in reality, these blocks represent logical, not necessarily actual, components. For example, one may consider a presentation component, such as a display device, to be an I/O component. Also, processors have memory. Accordingly, FIG. 5 is merely illustrative of an exemplary user device that can be used in connection with one or more embodiments of the technology disclosed herein.

User device 500 can include a variety of computer-readable media. Computer-readable media can be any available media that can be accessed by user device 500 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 500. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 504 includes computer storage media in the form of volatile and/or nonvolatile memory. The memory 504 may be removable, non-removable, or a combination thereof. Example hardware devices of memory 504 may include solid-state memory, hard drives, optical-disc drives, other hardware, or one or more combinations thereof. As indicated above, the computer storage media of the memory 504 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 500, or one or more combinations thereof.

The one or more processors 506 of user device 500 can read data from various entities, such as the memory 504 or the I/O component(s) 512. The one or more processors 506 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 506 can execute instructions, for example, of an operating system of the user device 500 or of one or more suitable applications.

The one or more presentation components 508 can present data indications via user device 500, another user device, or a combination thereof. Example presentation components 508 may include a display device, speaker, printing component, vibrating component, another type of presentation component, or one or more combinations thereof. In some embodiments, the one or more presentation components 508 may comprise one or more applications or services on a user device, across a plurality of user devices, or in the cloud. The one or more presentation components 508 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 510 allow user device 500 to be logically coupled to other devices, including the one or more I/O components 512, some of which may be built in. Example I/O components 512 can include a microphone, joystick, game pad, satellite dish, scanner, printer, wireless device, and the like. The one or more I/O components 512 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 508 on the user device 500. In some embodiments, the user device 500 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 500 may, additionally or alternatively, be equipped with accelerometers or gyroscopes that enable detection of motion. In some embodiments, the output of the accelerometers or gyroscopes may be provided to the one or more presentation components 508 of the user device 500 to render immersive augmented reality or virtual reality.

The power supply 514 of user device 500 may be implemented as one or more batteries or another power source for providing power to components of the user device 500. In embodiments, the power supply 514 can include an external power supply, such as an AC adapter or a powered docking cradle that supplements or recharges the one or more batteries. In aspects, the external power supply can override one or more batteries or another type of power source located within the user device 500.

Some embodiments of user device 500 may include one or more radios 516 (or similar wireless communication components). The one or more radios 516 can transmit, receive, or both transmit and receive signals for wireless communications. In embodiments, the user device 500 may be a wireless terminal adapted to receive communications and media over various wireless networks. User device 500 may communicate using the one or more radios 516 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 516 may facilitate communication via radio frequency signals, frames, blocks, transmission streams, packets, messages, data items, data, another type of wireless communication, or one or more combinations thereof. The one or more radios 516 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below.

Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system comprising:
a radio access network (RAN) node; and
a network manager communicatively coupled to the RAN node, the network manager configured to perform operations comprising:
determining, from data obtained from the RAN node, that a trigger event occurred;
extracting site configuration data based on determining that the trigger event occurred; and
using the site configuration data to create a new configuration file without overwriting a previous site configuration version.

2. The system according to claim 1 wherein the network manager further comprises a trigger event detection module configured to analyze incoming data and events to determine the occurrence of a trigger event.

3. The system according to claim 1, wherein the trigger event comprises network congestion exceeding a predetermined threshold.

4. The system according to claim 1, wherein the trigger event comprises receiving an indication that one or more components of the first RAN have failed.

5. The system according to claim 1, wherein the trigger event comprises determining that an equipment failure has occurred based on a threshold high degradation of one or more KPI parameters

6. The system according to claim 1, wherein the trigger event comprises receiving an indication of one or more configuration.

7. The system according to claim 1, wherein the trigger event comprises determining that an environmental event has occurred.

8. The system according to claim 1, wherein the network manager further comprises a data acquisition module configured to retrieve the site configuration data based on the detection of the trigger event.

9. The system according to claim 1, wherein the network manager further comprises a configuration file management module configured to generate the new configuration file using the site configuration data, without overwriting a previous site configuration version.

10. The system according to claim 1, wherein the trigger event is associated with at least a second RAN node.

11. The system according to claim 10, wherein the second RAN is a neighbor of the first or that they are within a predetermined threshold distance of each other.

12. The system according to claim 1, wherein the network manager further comprises a rollback mechanism configured to revert to a previous site configuration version in case of deployment errors or undesired consequences resulting from the new configuration file.

13. The system according to claim 1, wherein the network manager further comprises a performance monitoring module configured to monitor the performance of the RAN node after the deployment of a new configuration file and make adjustments as necessary to optimize performance.

14. A method comprising:
determining, from data obtained from a RAN node, that a trigger event occurred based on predefined criteria, wherein the trigger event includes at least one of network congestion, signal degradation, or performance deviation;
extracting specific site configuration data for the RAN node associated with the trigger event, wherein the trigger event comprises determining that an equipment failure has occurred based on a threshold high degradation of one or more KPI parameters; and
utilizing the extracted site configuration data to create a new configuration file without overwriting a previous site configuration version.

15. The method of claim 14 further comprising analyzing incoming data and events to determine the occurrence of a trigger event.

16. The method of claim 14, wherein the trigger event is associated with at least a second RAN node.

17. The method of claim 14, wherein a rollback mechanism is configured to revert to a previous site configuration version in case of deployment errors or undesired consequences resulting from the new configuration file.

18. One or more non-transitory computer storage media having computer-executable instructions embodied thereon, that when executed by at least one processor, cause the at least one processor to perform a method comprising:
determining, from data obtained from the RAN node, that a trigger event occurred;
extracting site configuration data for the RAN node based on determining that the trigger event occurred; and
using site configuration data to create a new configuration file without overwriting a previous site configuration version.

19. The one or more non-transitory computer storage media of claim 18, further comprising analyzing incoming data and events to determine the occurrence of the trigger event.

20. The one or more non-transitory computer storage media of claim 18, wherein the trigger event is associated with at least a second RAN node.
